(19) United States
(12) Patent Application Publication
(10) Pub. No.: US 2008/0024389 A1
(43) Pub. Date: Jan. 31, 2008

(54) Generation, transmission, and display of sub-frames

(76) Inventors: Eamonn O'Brien-Strain, Palo Alto, CA (US); Nelson L. Chang, Palo Alto, CA (US); Niranjan Damera-Venkata, Palo Alto, CA (US); Leonardo de Souza e Silva Tavares, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/494,687

(22) Filed: Jul. 27, 2006

(51) Int. Cl. G09G 5/00

(52) U.S. Cl. 345/1.2

(57) ABSTRACT

A method performed by a sub-frame generator coupled to a network interface includes receiving calibration information associated with a configuration of a plurality of projection devices in an image display system using the network interface, generating a plurality of sub-frames for display onto at least partially overlapping positions on a display surface by the plurality of projection devices using image data and the calibration information, and transmitting the plurality of sub-frames to the image display system using the network interface.

### CROSS-REFERENCE TO RELATED APPLICATION

This application is related to U.S. patent application Ser. No. 11/080,583, filed Mar. 15, 2005, and entitled PROJECTION OF OVERLAPPING SUB-FRAMES ONTO A SURFACE; and U.S. patent application Ser. No. 11/080,223, filed Mar. 15, 2005, and entitled PROJECTION OF OVERLAPPING SINGLE-COLOR SUB-FRAMES ONTO A SURFACE. These applications are incorporated by reference herein.

### BACKGROUND

Two types of projection display systems are digital light processor (DLP) systems, and liquid crystal display (LCD) systems. It is desirable in some projection applications to provide a high lumen level output, but it can be very costly to provide such output levels in existing DLP and LCD projection systems. Three choices exist for applications where high lumen levels are desired: (1) high-output projectors; (2) tiled, low-output projectors; and (3) superimposed, low-output projectors.

When information requirements are modest, a single high-output projector is typically employed. This approach dominates digital cinema today, and the images typically have a nice appearance. High-output projectors have the lowest lumen value (i.e., lumens per dollar). The lumen value of high output projectors is less than half of that found in low-end projectors. If the high output projector fails, the screen goes black. Also, parts and service are available for high output projectors only via a specialized niche market.

Tiled projection can deliver very high resolution, but it is difficult to hide the seams separating tiles, and output is often reduced to produce uniform tiles. Tiled projection can deliver the most pixels of information. For applications where large pixel counts are desired, such as command and control, tiled projection is a common choice. Registration, color, and brightness must be carefully controlled in tiled projection. Matching color and brightness is accomplished by attenuating output, which costs lumens. If a single projector fails in a tiled projection system, the composite image is ruined.

Superimposed projection provides excellent fault tolerance and full brightness utilization, but resolution is typically compromised. Algorithms that seek to enhance resolution by offsetting multiple projection elements have been previously proposed. These methods assume simple shift offsets between projectors, use frequency domain analyses, and rely on heuristic methods to compute component sub-frames. The proposed systems do not generate optimal sub-frames in real-time, and do not take into account arbitrary relative geometric distortion between the component projectors.

Existing projection systems do not provide a cost effective solution for high lumen level (e.g., greater than about 10,000 lumens) applications. In addition, the cost of a projection system may increase by including processing power for generating sub-frames.

### SUMMARY

One form of the present invention provides a method performed by a sub-frame generator coupled to a network interface. The method includes receiving calibration information associated with a configuration of a plurality of projection devices in an image display system using the network interface, generating a plurality of sub-frames for display onto at least partially overlapping positions on a display surface by the plurality of projection devices using image data and the calibration information, and transmitting the plurality of sub-frames to the image display system using the network interface.

### BRIEF DESCRIPTION OF THE DRAWINGS

FIG. 1A is a block diagram illustrating a system for generating, transmitting, and displaying sub-frames according to one embodiment of the present invention.

FIG. 1B is a block diagram illustrating a plurality of systems for generating, transmitting, and displaying sub-frames according to one embodiment of the present invention.

FIG. 2 is a flow chart illustrating a method for generating, transmitting, and displaying sub-frames according to one embodiment of the present invention.

FIG. 3 is a flow chart illustrating a method for generating and transmitting sub-frames for display according to one embodiment of the present invention.

FIG. 4 is a flow chart illustrating a method for displaying sub-frames according to one embodiment of the present invention.

FIGS. 5A-5D are schematic diagrams illustrating the projection of four sub-frames according to one embodiment of the present invention.

FIG. 6 is a diagram illustrating a model of an image formation process according to one embodiment of the present invention.

FIG. 7 is a diagram illustrating a model of an image formation process according to one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., may be used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

### I. Generation, Transmission, and Display of Sub-Frames

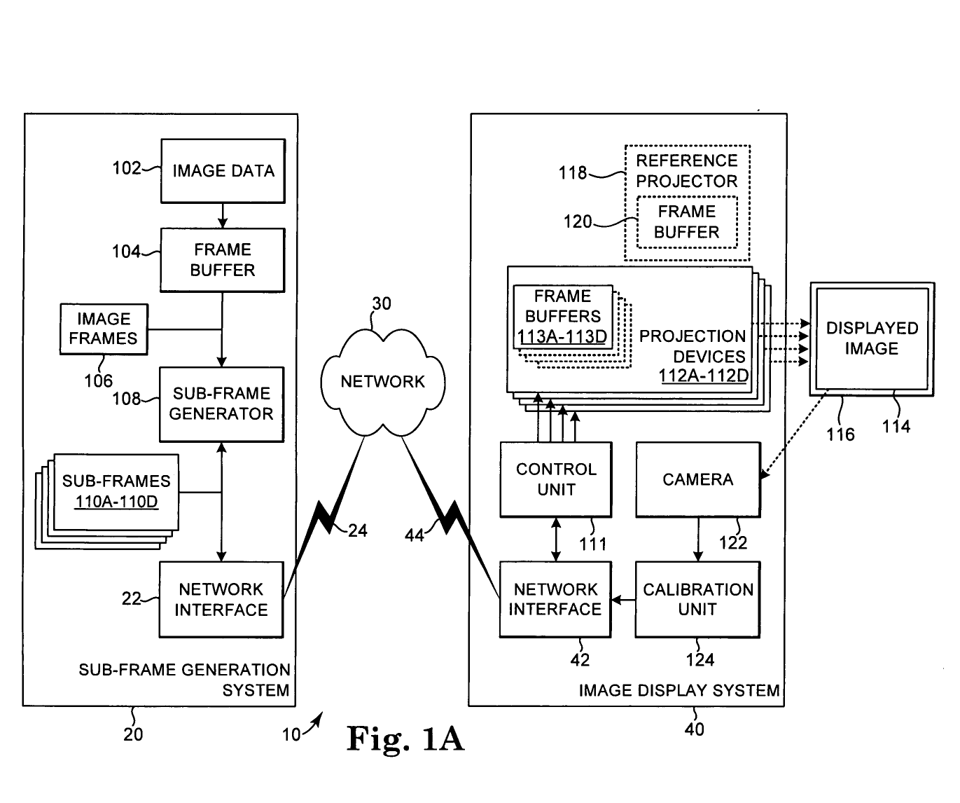

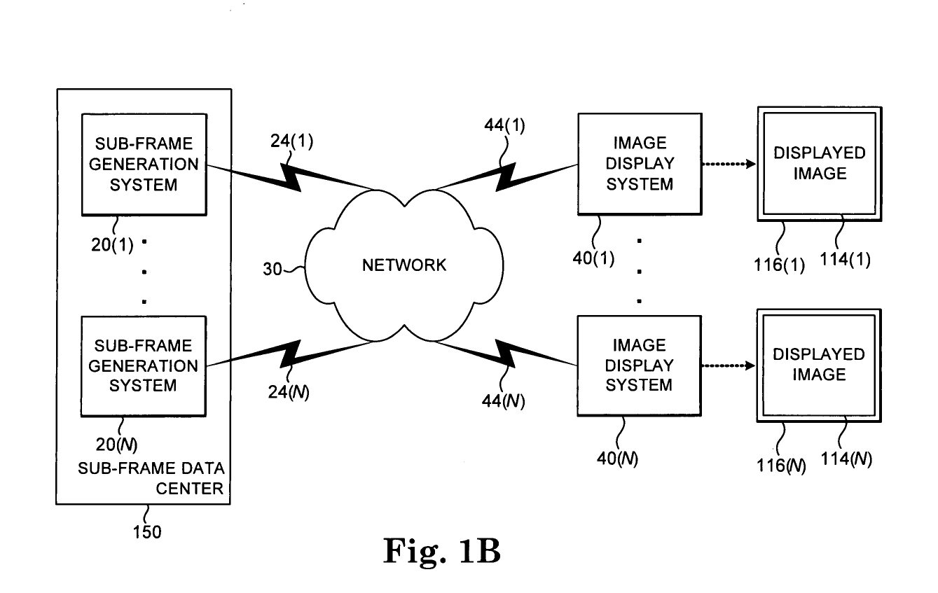

FIG. 1A is a block diagram illustrating a system 10 for generating, transmitting, and displaying sub-frames according to one embodiment. System 10 includes a sub-frame generation system 20, a network 30, and an image display system 40. In system 10, sub-frame generation system 20 processes image data 102 to generate sub-frames 110 for each of a set of projection devices 112 in image display system 40 and provides the sub-frames 110 to image display system 40 using network 30. Image display system 40 generates a corresponding displayed image 114 on a display surface 116 by simultaneously displaying sub-frames 110 in at least partially overlapping positions (e.g., tiled or superimposed positions) using projection devices 112. Displayed image 114 is defined to include any pictorial, graphical, or textural characters, symbols, illustrations, or other representations of information.

Sub-frame generation system 20 includes an image frame buffer 104, a sub-frame generator 108, and a network interface 22. Image display system 40 includes a network interface 42, a control unit 111, projection devices 112A-112D (collectively referred to as projection devices 112), image frame buffers 113A-113D (collectively referred to as frame buffers 113), one or more cameras 122, and calibration unit 124.

Image frame buffer 104 receives and buffers image data 102 to create image frames 106. Image data 102 may comprise any suitable still or video image format with any suitable resolution. For example, image data 102 may be in a High Definition (HD) television 1080p (1920×1080 resolution) format, a digital cinema 2K (2048×1080 resolution) format, or digital cinema 4K (4096×2160 resolution) format. Image frame buffer 104 includes memory for storing image data 102 for one or more image frames 106. Thus, image frame buffer 104 constitutes a database of one or more image frames 106. Examples of image frame buffer 104 include non-volatile memory (e.g., a hard disk drive or other persistent storage device) and may include volatile memory (e.g., random access memory (RAM)).

Sub-frame generator 108 receives and processes image frames 106 to define corresponding image sub-frames 110A-110D (collectively referred to as sub-frames 110) using calibration information provided by image display system 40 and received using network interface 22. As described in additional detail below, the calibration information specifies a configuration of projection devices 112, display surface 116, and one or more cameras 122 in image display system 40.

In the exemplary embodiment of FIG. 1A, for each image frame 106, sub-frame generator 108 generates one sub-frame 110A for projection device 112A, one sub-frame 110B for projection device 112B, one sub-frame 110C for projection device 112C, and one sub-frame 110D for projection device 112D. In other embodiments, sub-frame generator 108 generates a set of sub-frames 110 for each image frame 106 where the number of sub-frames in the set is less than or equal to the number of projection devices 112 in image display system 40.

Sub-frame generator 108 generates sub-frames 110 based on image data in image frames 106. In one embodiment, sub-frame generator 108 generates image sub-frames 110 with a resolution that matches the resolution of projection devices 112, which is less than the resolution of image frames 106 in one embodiment (e.g., XGA format with a resolution of 1024×768). Sub-frames 110 each include a plurality of columns and a plurality of rows of individual pixels representing a subset of an image frame 106.

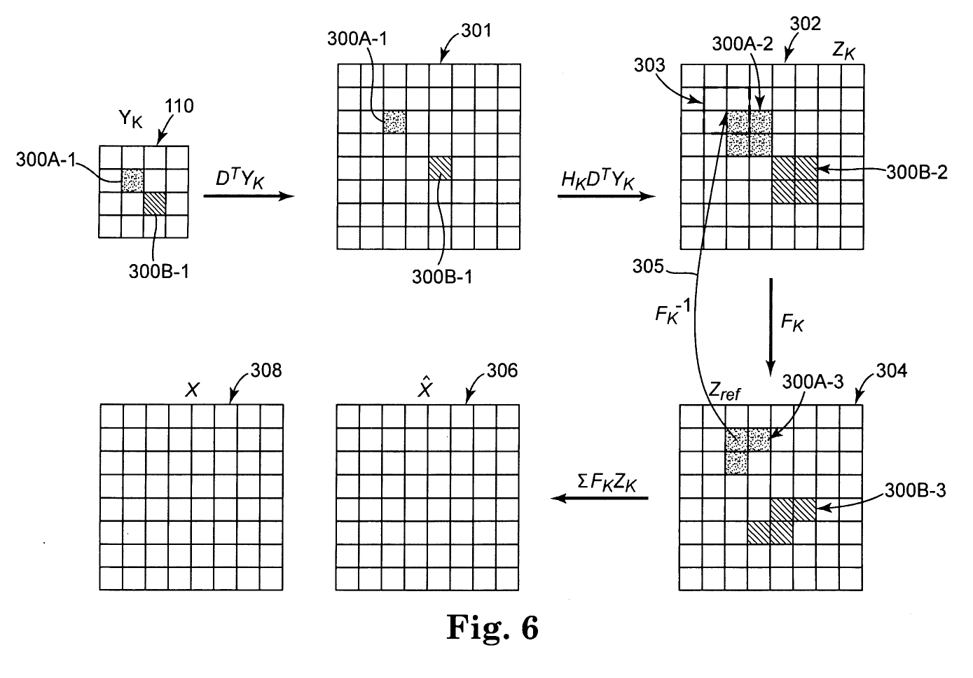

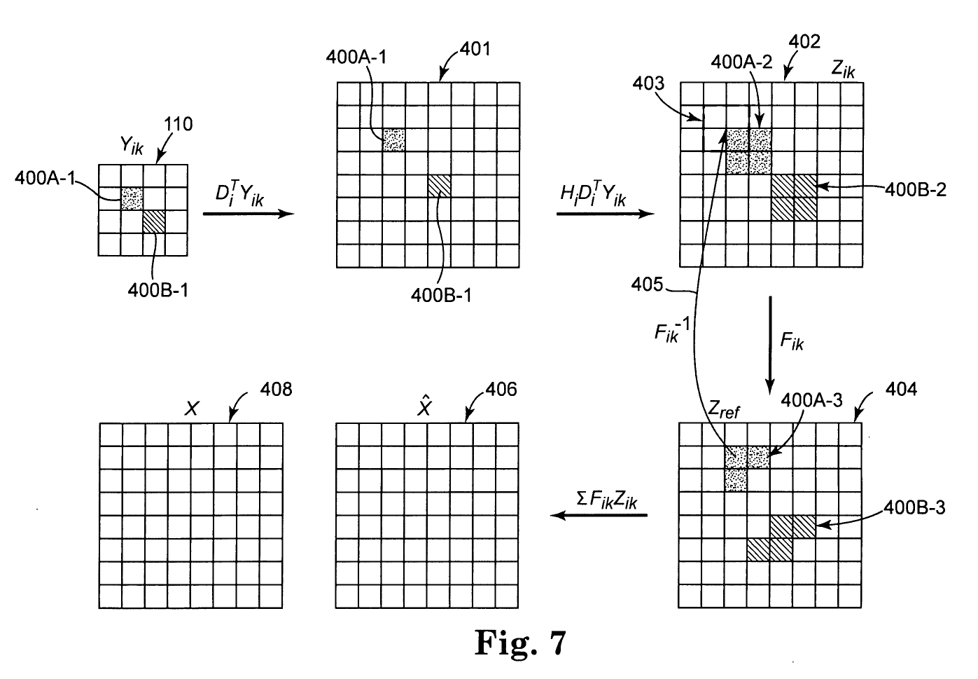

Sub-frame generator 108 determines appropriate values for sub-frames 110 so that the displayed image 114 produced by the projected sub-frames 110 is close in appearance to how the high-resolution image (e.g., image frame 106) from which sub-frames 110 were derived would appear if displayed directly. Sub-frame generator 108 may determine appropriate values for sub-frames 110 using the embodiments described with reference to FIGS. 6 and 7 below.

By generating sub-frames 110 using the calibration information from image display system 40, sub-frame generator 108 generates sub-frames 110 such that sub-frames 110 would not display properly on another display system. Accordingly, the display of sub-frames 110 by another display system would likely result in a significant reduction of image quality.

In one embodiment, sub-frame generator 108 generates sub-frames 110 with distortion such that distortion is not visible (i.e., the distortion cancels) when all sub-frames 110 are displayed simultaneously in at least partially overlapping positions using projection devices 112. Sub-frame generator 108 generates sub-frames 110 with distortion such that the distortion is visible when fewer than all sub-frames 110 are displayed simultaneously in at least partially overlapping positions using projection devices 112. Sub-frame generator 108 may generate the distortion by including random or non-random noise (e.g., a pattern such as a moiré pattern) or by including only a subset of image data 102 in each sub-frame 110 (e.g., a grayscale range or a single color). The distortion of sub-frames 110 may form defined patterns, such as moire patterns, such that the patterns are visible when, for example, a single sub-frame 110 with distortion is displayed separately from the remaining sub-frames 110.

Additional information regarding the use of distortion in sub-frames 110 may be found in co-pending U.S. Patent U.S. patent application Ser. No. 11/298,233, filed Dec. 9, 2005, and entitled PROJECTION OF OVERLAPPING SUB-FRAMES ONTO A SURFACE; and U.S. patent application Ser. No. 11/298,190, filed Dec. 9, 2005, and entitled GENERATION OF IMAGE DATA SUBSETS. These applications are incorporated by reference herein.

In one embodiment, sub-frame generator 108 encrypts sub-frames 110 using any suitable encryption technique prior to sub-frames 110 being transmitted to image display system 40. Sub-frame generator 108 may use an encryption key to perform the encryption such that image display system 40 also includes an encryption key that may be use to decrypt sub-frames 110.

In one embodiment, sub-frame generator 108 receives diagnostic information from image display system 40 using network interface 22. As described in additional detail below, the diagnostic information may include any type of information associated with the operating status or condition of components in image display system 40. Sub-frame generator 108 may store the diagnostic information in logs, generate errors associated with the diagnostic information, or otherwise provide notifications to a user regarding the diagnostic information.

In one embodiment, sub-frame generator 108 compresses sub-frames 110 using redundant information in sub-frames 110. By compressing sub-frames 110, sub-frame generator 108 may reduce the size of the memory used to store sub-frames 110.

It will be understood by a person of ordinary skill in the art that functions performed by sub-frame generator 108 may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory, and random access memory.

Sub-frame generator 108 provides sub-frames 110 to network interface 22. Network interface 22 configures or translates sub-frames 110 in accordance with any suitable network protocol or combination of protocols and transmits sub-frames 110 to image display system 40 using one or more network connections 24 to network 30. Network connection 24 may be any suitable set of wired or wireless network connections to network 30.

Network 30 includes any number of wired or wireless network devices (not shown) configured to receive sub-frames 110 from sub-frame generation system 20 using network connections 24 and provide sub-frames 110 to image display system 40 using one or more network connections 44. Network 30 may transmit sub-frames 110 using any suitable network protocol or combination of protocols.

Image display system 40 receives sub-frames 110A-110D using network interface 42. Control unit 111 de-multiplexes sub-frames 110A-110D and stores sub-frames 110A-110D in image frame buffers 113A-113D, respectively, of projection devices 112A-112D, respectively. Control unit 111 decrypts or decompresses sub-frames 110A-110D, as appropriate, prior to storing sub-frames 110A-110D in image frame buffers 113A-113D.

Image frame buffers 113 include memory for storing any number of sub-frames 110. Examples of image frame buffers 113 include non-volatile memory (e.g., a hard disk drive or other persistent storage device) and may include volatile memory (e.g., random access memory (RAM)).

Projection devices 112A-112D access sub-frames 110A-110D from image frame buffers 113A-113D, respectively, and project sub-frames 110A-110D, respectively, onto display surface 116 to produce displayed image 114 for viewing by a user. In one embodiment, projection devices 112 simultaneously or substantially simultaneously project sub-frames 110 onto display surface 116 at overlapping and spatially offset positions to produce displayed image 114. Accordingly, image display system 40 is configured to give the appearance to the human eye of high-resolution displayed images 114 by displaying overlapping and spatially shifted lower-resolution sub-frames 110 from multiple projection devices 112. In one form of the invention, the projection of overlapping and spatially shifted sub-frames 110 gives the appearance of enhanced resolution (i.e., higher resolution than sub-frames 110 themselves).

Also shown in FIG. 1A is reference projector 118 with an image frame buffer 120. Reference projector 118 is shown with hidden lines in FIG. 1A because, in one embodiment, projector 118 is not an actual projector, but rather is a hypothetical high-resolution reference projector that is used in an image formation model for generating optimal sub-frames 110, as described in further detail below with reference to the embodiments of FIGS. 6 and 7. In one embodiment, the location of one of the actual projection devices 112 is defined to be the location of the reference projector 118.

Calibration unit 124 generates calibration information associated with the display of image 114 on surface 116 by projection devices 112 using calibration images (not shown) captured by one or more cameras 122. The calibration information specifies a configuration of projection devices 112, display surface 116, and one or more cameras 122 to allow sub-frames 110 to be generated by sub-frame generator 108 for the specific configuration of image display system 40. According to one embodiment, the calibration information includes a geometric mapping between each projection device 112 and the reference projector 118 as described in additional detail below with reference to the embodiments of FIGS. 6 and 7. In addition, the calibration information may include luminance, color, and black offset information.

Calibration unit 124 provides the calibration information to network interface 42. Network interface 42 transmits the calibration information to sub-frame generation system 20 using one or more network connections 44. Network interface 42 configures or translates the calibration information in accordance with any suitable network protocol or combination of protocols and transmits the calibration information to sub-frame generation system 20 using network connection 44. Network connection 44 may be any suitable set of wired or wireless network connections to network 30.

In other embodiments (not shown), calibration unit 124 is included in sub-frame generation system 20. In this embodiment, image display system 40 transmits calibration images captured by one or more cameras 122 as the calibration information across network 30 using network interface 42. Sub-frame generation system 20 receives the calibration images from network 30 using network interface 22. Calibration unit 124 processes the calibration images to produce calibration information and provides the calibration information to sub-frame generator 108 using any suitable connection within sub-frame generation system 20.

In one embodiment, control unit 111 is configured to generate diagnostic information associated with the operation status or condition of control unit 111, projection devices 112, one or more cameras 122, calibration unit 124, and network interface 42. For example, the diagnostic information may indicate that a projector bulb of a projection device 112 has failed. Control unit 111 provides the diagnostic information to network interface 42. Network interface 42 transmits the diagnostic information to sub-frame generation system 20 using network connection 44.

Image display system 40 (e.g., control unit 111 and calibration unit 124) includes any suitable configuration that includes hardware, software, firmware, or a combination of these.

In one embodiment, sub-frame generation system 20 may be configured as a server computer system and image display system 40 may be configured as a client computer system. In this embodiment, image display system 40 is located remotely from sub-frame generation system 20. Accordingly, network 30 may include any suitable wide area network (e.g., the Internet), at least a portion of a switched telephone network, or any other suitable computer network.

FIG. 1B is a block diagram illustrating a plurality of systems 10(1) through 10(N) for generating, transmitting, and displaying sub-frames where N is greater than or equal to two. Each system 10 includes a respective one of sub-frame generation systems 20(1) through 20(N), a respective one of network connections 24(1) through 24(N), a portion of network 30, a respective one of network connections 44(1) through 44(N), and a respective one of image data systems 40(1) through 40(N).

A sub-frame data center 150 includes a plurality of sub-frame generation systems 20(1) through 20(N) (collectively referred to as sub-frame generation systems 20). Sub-frame generation systems 20 generate sets of sub-frames 110 for respective image display systems 40(1) through 40(N) (collectively referred to as image display systems 40). Image display systems 40 display the respective sets of sub-frames 110 to form respective displayed images 114(1) through 114(N) (collectively referred to as displayed images 114) on respective display surfaces 116(1) through 116(N) (collectively referred to as display surfaces 116)

Image display systems 40 transmit calibration information to respective sub-frame generation systems 20 as described above with reference to FIG. 1A. Accordingly, sub-frame generation systems 20 generate sets of sub-frames 110 for respective image display systems 40 using the respective calibration information. For example, sub-frame generation system 20(1) generates sets of sub-frames 110 for image display systems 40(1) using calibration information provided by image display systems 40(1) to sub-frame generation system 20(1).

Sub-frame generation systems 20 transmit the sets of sub-frames 110 to respective image display systems 40 across network 30 using respective network connections 24(1) through 24(N) (collectively referred to as network connections 24). Image display systems 40 receive the sets of sub-frames 110 using respective network connections 44(1) through 44(N) (collectively referred to as network connections 44).

Image display systems 40 transmit the calibration information to respective sub-frame generation systems 20 across network 30 using network connections 44. Sub-frame generation systems 20 receive the calibration information using respective network connections 24.

Sub-frame data center 150 forms a single central location for generating and transmitting set of sub-frames 110. Image display systems 40 may each be remotely located from sub-frame data center 150 in one or more locations.

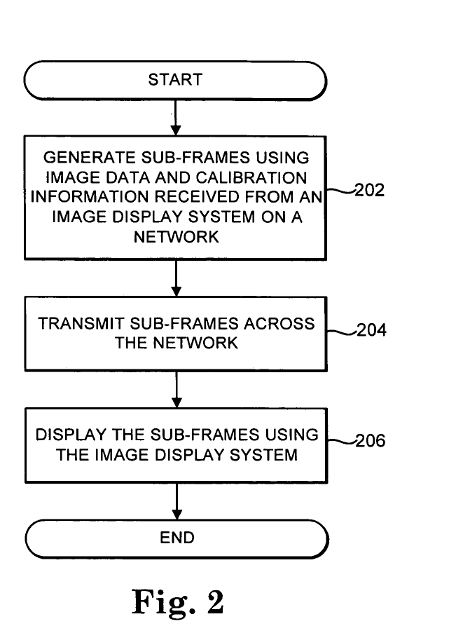

FIG. 2 is a flow chart illustrating a method for generating, transmitting, and displaying sub-frames 110 according to one embodiment. The embodiment of FIG. 2 will be described with reference to system 10 in FIG. 1A.

In FIG. 2, sub-frame generation system 20 generates sub-frames 110 using image data 102 and calibration information received from image display system 40 on network 30 as indicated in a block 202. Sub-frame generation system 20 transmits sub-frames 110 across network 30 as indicated in a block 204. Image display system 40 displays sub-frames 110 as indicated in a block 206.

The method of FIG. 2 illustrates the generation and transmission of sub-frames 110 for a single image frame 106. Accordingly, the method of FIG. 2 may be repeated for each successive image frame 106.

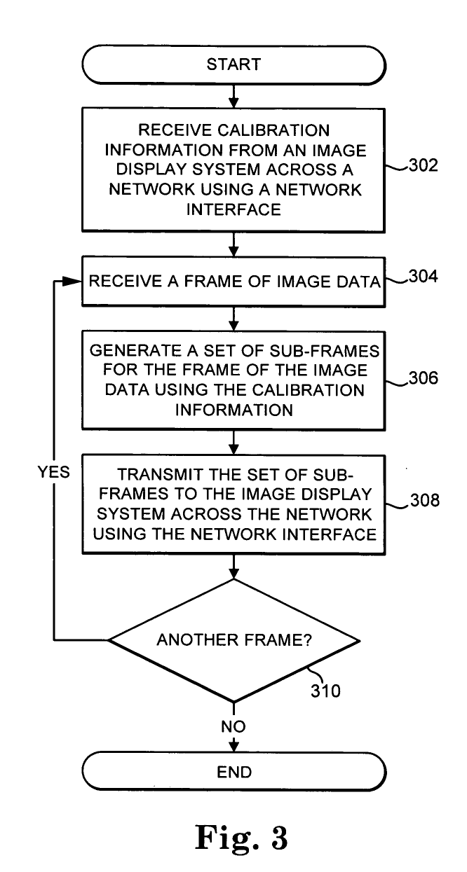

FIG. 3 is a flow chart illustrating a method for generating and transmitting sub-frames for display according to one embodiment. The embodiment of FIG. 3 will be described with reference to sub-frame generation system 20 in FIG. 1A.

In FIG. 3, sub-frame generation system 20 receives calibration information from image display system 40 across network 30 using network interface 22 as indicated in a block 302. Network interface 22 causes the calibration information to be provided to or stored in a location that is accessible to sub-frame generator 108. Sub-frame generator 108 receives an image frame 106 of image data 102 from frame buffer 104 as indicated in a block 304. Sub-frame generator 108 generates a set of sub-frames 110 for image frame 106 using the calibration information as indicated in a block 306. In particular, sub-frame generator 108 determines the values of sub-frames 110 in accordance with the configuration of image display system 40 using the calibration information to allow sub-frames to be displayed with image display system 40.

Sub-frame generator 108 transmits the set of sub-frames 110 to image display system 40 across network 30 using network interface 22 as indicated in a block 308. Prior to transmitting set of sub-frames 110, sub-frame generator 108 may distort, encrypt, or compress sub-frames 110 as described in additional detail above.

A determination is made as to whether there is another image frame 106 as indicated in a block 310. If there is not another image frame 106, then the method ends. If there is another image frame 106, then the method repeats the functions of blocks 304 through 310 for the next image frame 106.

In one embodiment, sub-frame generator 108 uses the calibration information received in performing the function of block 302 to perform the function of block 306 for each image frame 106. In other embodiments, sub-frame generator 108 repeats the function of block 302 for each image frame 106 such that sub-frame generator 108 continuously receives calibration information from image display system 40.

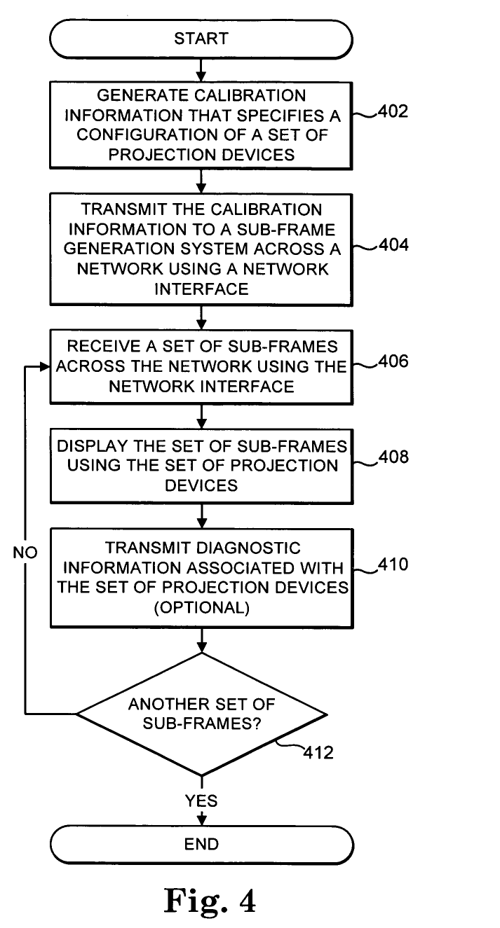

FIG. 4 is a flow chart illustrating a method for displaying sub-frames according to one embodiment. The embodiment of FIG. 4 will be described with reference to image display system 40 in FIG. 1A.

In FIG. 4, image display system 40 generates calibration information that specifies a configuration of the set of projections devices 112 as indicated in a block 402. More particularly, calibration unit 124 processes one or more images displayed by projection devices 112 and captured by one or more cameras 122 to determine the configuration. Image display system 40 transmits the calibration information to sub-frame generation system 20 across network 30 using network interface 42 as indicated in a block 404.

Image display system 40 receives a set of sub-frames 110 across network 30 using network interface 42 as indicated in a block 404. Control unit 111 receives sub-frames 110 from network interface 42 and stores sub-frames 110 in respective frame buffers 113 of projection devices 112. Control unit 111 may decrypt or decompress sub-frames 110 as appropriate prior to storing sub-frames 110 in frame buffers 113. Image display system 40 displays the set of sub-frames 110 using the set of projection devices 112 as indicated in a block 406. More particularly, projection devices 112 each simultaneously display a respective sub-frame 110 in at least partially overlapping positions.

Image display system 40 optionally transmits diagnostic information associated with the set of projection devices 112 to sub-frame generation system 20 across network 30 using network interface 42 as indicated in a block 410. Control unit 111 generates the diagnostic information continuously or periodically and transmits the diagnostic information to image display system 40. Control unit 111 may transmit the diagnostic information in response to receiving a command from image display system 40.

A determination is made as to whether another set of sub-frames is to be displayed as indicated in a block 412. The determination may be made according to a mode of operation of image display system 40 (e.g., a video mode or a still image mode) or may be made in response to detecting additional sets of sub-frames that are transmitted by sub-frame generation system 20. If another set of sub-frames is not to be displayed, then the method ends. If another set of sub-frames is to be displayed, then the function of blocks 406 and 408 is repeated.

In the embodiment of FIG. 4, image display system 40 generates and transmits the calibration information once in performing the function of block 402 and 404. In other embodiments, the functions of blocks 402 and 404 are repeated continuously or periodically by calibration unit 124 to provide calibration information to sub-frame generation system 20.

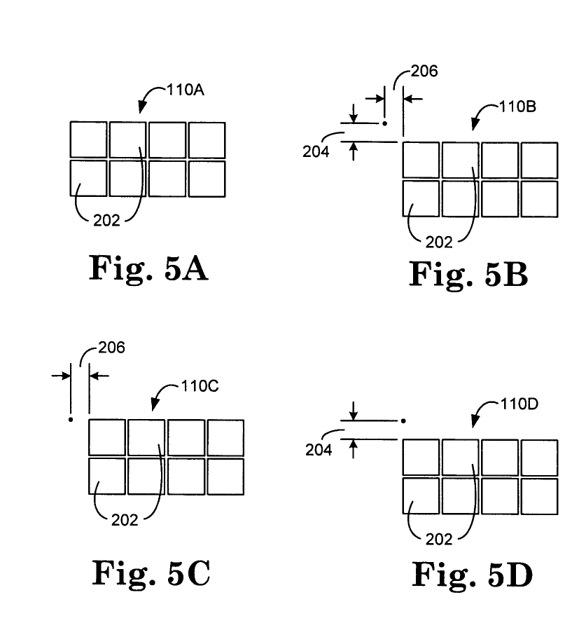

FIGS. 5A-5D are schematic diagrams illustrating the projection of four sub-frames 110A, 110B, 110C, and 110D according to one exemplary embodiment. In this embodiment, display system 40 includes four projection devices 112.

FIG. 5A illustrates the display of sub-frame 110A by a first projection device 112A. As illustrated in FIG. 5B, a second projection device 112B displays sub-frame 110B offset from sub-frame 110A by a vertical distance 204 and a horizontal distance 206. As illustrated in FIG. 5C, a third projection device 112C displays sub-frame 110C offset from sub-frame 110A by horizontal distance 206. A fourth projection device 112 displays sub-frame 110D offset from sub-frame 110A by vertical distance 204 as illustrated in FIG. 5D.

Sub-frame 110A is spatially offset from first sub-frame 110B by a predetermined distance. Similarly, sub-frame 110C is spatially offset from first sub-frame 110D by a predetermined distance. In one illustrative embodiment, vertical distance 204 and horizontal distance 206 are each approximately one-half of one pixel.

The display of sub-frames 100B, 110C, and 110D are spatially shifted relative to the display of sub-frame 110A by vertical distance 204, horizontal distance 206, or a combination of vertical distance 204 and horizontal distance 206. As such, pixels 202 of sub-frames 110A, 110B, 110C, and 110D overlap thereby producing the appearance of higher resolution pixels. Sub-frames 110A, 110B, 110C, and 110D may be superimposed on one another (i.e., fully or substantially fully overlap), may be tiled (i.e., partially overlap at or near the edges), or may be a combination of superimposed and tiled. The overlapped sub-frames 110A, 101B, 110C, and 110D also produce a brighter overall image than any of sub-frames 110A, 110B, 110C, or 110D alone.

In other embodiments, sub-frames 110A, 110B, 110C, and 110D may be displayed at other spatial offsets relative to one another and the spatial offsets may vary over spatially, temporally, or any suitable combination of spatially and temporally.

In one embodiment, sub-frames 110 have a lower resolution than image frames 106. Thus, sub-frames 110 are also referred to herein as low-resolution images or sub-frames 110, and image frames 106 are also referred to herein as high-resolution images or frames 106. The terms low resolution and high resolution are used herein in a comparative fashion, and are not limited to any particular minimum or maximum number of pixels.

### II. Sub-Frame Generation

Sub-frame generator 108 may determine appropriate values for sub-frames 110 using the embodiments described with reference to FIGS. 6 and 7 below.

In one embodiment, display system 40 produces a superimposed projected output that takes advantage of natural pixel mis-registration to provide a displayed image with a higher resolution than the individual sub-frames 110. In one embodiment, image formation due to multiple overlapped projection devices 112 is modeled using a signal processing model. Optimal sub-frames 110 for each of the component projection devices 112 are estimated by sub-frame generator 108 based on the model, such that the resulting image predicted by the signal processing model is as close as possible to the desired high-resolution image to be projected. In one embodiment, the signal processing model is used to derive values for sub-frames 110 that minimize visual color artifacts that can occur due to offset projection of single-color sub-frames 110.

In one embodiment, sub-frame generator 108 is configured to generate sub-frames 110 based on the maximization of a probability that, given a desired high resolution image, a simulated high-resolution image that is a function of the sub-frame values, is the same as the given, desired high-resolution image. If the generated sub-frames 110 are optimal, the simulated high-resolution image will be as close as possible to the desired high-resolution image. The generation of optimal sub-frames 110 based on a simulated high-resolution image and a desired high-resolution image is described in further detail below with reference to the embodiment of FIG. 6 and the embodiment of FIG. 7.

A. Multiple Color Sub-Frames

FIG. 6 is a diagram illustrating a model of an image formation process performed by sub-frame generator 108 in sub-frame generation system 20. Sub-frames 110 are represented in the model by Yₖ, where “k” is an index for identifying the individual projection devices 112. Thus, Y₁, for example, corresponds to a sub-frame 110 for a first projection device 112, Y₂ corresponds to a sub-frame 110 for a second projection device 112, etc. Two of the sixteen pixels of the sub-frame 110 shown in FIG. 6 are highlighted, and identified by reference numbers 300A-1 and 300B-1. Sub-frames 110 (Yₖ) are represented on a hypothetical high-resolution grid by up-sampling (represented by D^{T}) to create up-sampled image 301. The up-sampled image 301 is filtered with an interpolating filter (represented by Hₖ) to create a high-resolution image 302 (Zₖ) with “chunky pixels”. This relationship is expressed in the following Equation I:

Zₖ=HₖD^{T}Yₖ Equation I

where:
k=index for identifying the projection devices 112;
Zₖ=low-resolution sub-frame 110 of the kth projection device 112 on a hypothetical high-resolution grid;
Hₖ=Interpolating filter for low-resolution sub-frame 110 from kth projection device 112;
D^{T}=up-sampling matrix; and
Yₖ=low-resolution sub-frame 110 of the kth projection device 112.

The low-resolution sub-frame pixel data (Yₖ) is expanded with the up-sampling matrix (D^{T}) so that sub-frames 110 (Yₖ) can be represented on a high-resolution grid. The interpolating filter (Hₖ) fills in the missing pixel data produced by up-sampling. In the embodiment shown in FIG. 6, pixel 300A-1 from the original sub-frame 110 (Yₖ) corresponds to four pixels 300A-2 in the high-resolution image 302 (Zₖ), and pixel 300B-1 from the original sub-frame 110 (Yₖ) corresponds to four pixels 300B-2 in the high-resolution image 302 (Zₖ). The resulting image 302 (Zₖ) in Equation I models the output of the k^{th} projection device 112 if there was no relative distortion or noise in the projection process. Relative geometric distortion between the projected component sub-frames 110 results due to the different optical paths and locations of the component projection devices 112. A geometric transformation is modeled with the operator, Fₖ, which maps coordinates in the frame buffer 113 of the k^{th} projection device 112 to frame buffer 120 of hypothetical reference projector 118 with sub-pixel accuracy, to generate a warped image 304 (Z_{ref}). In one embodiment, Fₖ is linear with respect to pixel intensities, but is non-linear with respect to the coordinate transformations. As shown in FIG. 6, the four pixels 300A-2 in image 302 are mapped to the three pixels 300A-3 in image 304, and the four pixels 300B-2 in image 302 are mapped to the four pixels 300B-3 in image 304.

In one embodiment, the geometric mapping (Fₖ) is a floating-point mapping, but the destinations in the mapping are on an integer grid in image 304. Thus, it is possible for multiple pixels in image 302 to be mapped to the same pixel location in image 304, resulting in missing pixels in image 304. To avoid this situation, in one embodiment, during the forward mapping (Fₖ), the inverse mapping (Fₖ⁻¹) is also utilized as indicated at 305 in FIG. 6. Each destination pixel in image 304 is back projected (i.e., Fₖ⁻¹) to find the corresponding location in image 302. For the embodiment shown in FIG. 6, the location in image 302 corresponding to the upper-left pixel of the pixels 300A-3 in image 304 is the location at the upper-left corner of the group of pixels 300A-2. In one embodiment, the values for the pixels neighboring the identified location in image 302 are combined (e.g., averaged) to form the value for the corresponding pixel in image 304. Thus, for the example shown in FIG. 6, the value for the upper-left pixel in the group of pixels 300A-3 in image 304 is determined by averaging the values for the four pixels within the frame 303 in image 302.

In another embodiment, the forward geometric mapping or warp (Fₖ) is implemented directly, and the inverse mapping (Fₖ⁻¹) is not used. In one form of this embodiment, a scatter operation is performed to eliminate missing pixels. That is, when a pixel in image 302 is mapped to a floating point location in image 304, some of the image data for the pixel is essentially scattered to multiple pixels neighboring the floating point location in image 304. Thus, each pixel in image 304 may receive contributions from multiple pixels in image 302, and each pixel in image 304 is normalized based on the number of contributions it receives.

A superposition/summation of such warped images 304 from all of the component projection devices 112 forms a hypothetical or simulated high-resolution image 306 (\hat{X}, also referred to as X-hat herein) in reference projector frame buffer 120, as represented in the following Equation II:

$$\hat{X} = {\sum }_{k} {F}_{k} {Z}_{k} \qquad Equation II$$

where:
k=index for identifying the projection devices 112;
X-hat=hypothetical or simulated high-resolution image 306 in the reference projector frame buffer 120;
Fₖ=operator that maps a low-resolution sub-frame 110 of the kth projection device 112 on a hypothetical high-resolution grid to the reference projector frame buffer 120; and
Zₖ=low-resolution sub-frame 110 of kth projector 112 on a hypothetical high-resolution grid, as defined in Equation I.

If the simulated high-resolution image 306 (X-hat) in reference projector frame buffer 120 is identical to a given (desired) high-resolution image 308 (X), the system of component low-resolution projection devices 112 would be equivalent to a hypothetical high-resolution projector placed at the same location as hypothetical reference projector 118 and sharing its optical path. In one embodiment, the desired high-resolution images 308 are the high-resolution image frames 106 received by sub-frame generator 108.

In one embodiment, the deviation of the simulated high-resolution image 306 (X-hat) from the desired high-resolution image 308 (X) is modeled as shown in the following Equation III:

X=\hat{X}+η Equation III

where:
X=desired high-resolution frame 308;
X-hat=hypothetical or simulated high-resolution frame 306 in reference projector frame buffer 120; and
η=error or noise term.

As shown in Equation III, the desired high-resolution image 308 (X) is defined as the simulated high-resolution image 306 (X-hat) plus η, which in one embodiment represents zero mean white Gaussian noise.

The solution for the optimal sub-frame data (Yₖ*) for sub-frames 110 is formulated as the optimization given in the following Equation IV:

$${Y}_{k}^{*} = {arg max}_{{Y}_{k}} P ( \hat{X} \vert X ) \qquad Equation IV$$

where:
k=index for identifying the projection devices 112;
Yₖ*=optimum low-resolution sub-frame 110 of the kth projection device 112;
Yₖ=low-resolution sub-frame 110 of the kth projection device 112;
X-hat=hypothetical or simulated high-resolution frame 306 in reference projector frame buffer 120, as defined in Equation II;
X=desired high-resolution frame 308; and
P(X-hat|X)=probability of X-hat given X.

Thus, as indicated by Equation IV, the goal of the optimization is to determine the sub-frame values (Yₖ) that maximize the probability of X-hat given X. Given a desired high-resolution image 308 (X) to be projected, sub-frame generator 108 determines the component sub-frames 110 that maximize the probability that the simulated high-resolution image 306 (X-hat) is the same as or matches the “true” high-resolution image 308 (X).

Using Bayes rule, the probability P(X-hat|X) in Equation IV can be written as shown in the following Equation V:

$$P \text{(} \hat{X} \vert X ) = \frac{P ( X \vert \hat{X} ) P ( \hat{X} )}{P ( X )} \qquad Equation V$$

where:
X-hat=hypothetical or simulated high-resolution frame 306 in reference projector frame buffer 120, as defined in Equation II;
X=desired high-resolution frame 308;
P(X-hat|X)=probability of X-hat given X;
P(X|X-hat)=probability of X given X-hat;
P(X-hat)=prior probability of X-hat; and
P(X)=prior probability of X.

The term P(X) in Equation V is a known constant. If X-hat is given, then, referring to Equation III, X depends only on the noise term, η, which is Gaussian. Thus, the term P(X|X-hat) in Equation V will have a Gaussian form as shown in the following Equation VI:

$$P \text{(} X \vert \hat{X} ) = \frac{1}{C} {e}^{- \frac{{‖ X - \hat{X} ‖}^{2}}{2 {σ}^{2}}} \qquad Equation VI$$

where:
X-hat=hypothetical or simulated high-resolution frame 306 in reference projector frame buffer 120, as defined in Equation II;
X=desired high-resolution frame 308;
P(X|X-hat)=probability of X given X-hat;
C=normalization constant; and
σ=variance of the noise term, η.

To provide a solution that is robust to minor calibration errors and noise, a “smoothness” requirement is imposed on X-hat. In other words, it is assumed that good simulated images 306 have certain properties. The smoothness requirement according to one embodiment is expressed in terms of a desired Gaussian prior probability distribution for X-hat given by the following Equation VII:

$$P ( \hat{X} ) = \frac{1}{Z ( β )} {e}^{- \{ {β}^{2} ( {‖ ∇ \hat{X} ‖}^{2} ) \}} \qquad Equation VII$$

where:
P(X-hat)=prior probability of X-hat;
β=smoothing constant;
Z(β)=normalization function;
∇=gradient operator; and
X-hat=hypothetical or simulated high-resolution frame 306 in reference projector frame buffer 120, as defined in Equation II.

In another embodiment, the smoothness requirement is based on a prior Laplacian model, and is expressed in terms of a probability distribution for X-hat given by the following Equation VIII:

$$P ( \hat{X} ) = \frac{1}{Z ( β )} {e}^{- \{ β ( ‖ ∇ \hat{X} ‖ ) \}} \qquad Equation VIII$$

where:
P(X-hat)=prior probability of X-hat;
β=smoothing constant;
Z(β)=normalization function;
∇=gradient operator; and
X-hat=hypothetical or simulated high-resolution frame 306 in reference projector frame buffer 120, as defined in Equation II.

The following discussion assumes that the probability distribution given in Equation VII, rather than Equation VIII, is being used. As will be understood by persons of ordinary skill in the art, a similar procedure would be followed if Equation VIII were used. Inserting the probability distributions from Equations VI and VII into Equation V, and inserting the result into Equation IV, results in a maximization problem involving the product of two probability distributions (note that the probability P(X) is a known constant and goes away in the calculation). By taking the negative logarithm, the exponents go away, the product of the two probability distributions becomes a sum of two probability distributions, and the maximization problem given in Equation IV is transformed into a function minimization problem, as shown in the following Equation IX:

$${Y}_{k}^{*} = {arg min}_{{Y}_{k}} {‖ X - \hat{X} ‖}^{2} + {β}^{2} {‖ ∇ \hat{X} ‖}^{2} \qquad Equation IX$$

where:
k=index for identifying the projection devices 112;
Yₖ*=optimum low-resolution sub-frame 110 of the kth projection device 112;
Yₖ=low-resolution sub-frame 110 of the kth projection device 112;
X-hat=hypothetical or simulated high-resolution frame 306 in reference projector frame buffer 120, as defined in Equation II;
X=desired high-resolution frame 308;
β=smoothing constant; and
∇=gradient operator.

The function minimization problem given in Equation IX is solved by substituting the definition of X-hat from Equation II into Equation IX and taking the derivative with respect to Yₖ, which results in an iterative algorithm given by the following Equation X:

Yₖ⁽ⁿ⁺¹⁾=Yₖ⁽ⁿ⁾−Θ{DHₖ^{T}Fₖ^{T}└(\hat{X}⁽ⁿ⁾−X)+β²∇²\hat{X}⁽ⁿ⁾ Equation X

where:
k=index for identifying the projection devices 112;
n=index for identifying iterations;
Yₖ⁽ⁿ⁺¹⁾=low-resolution sub-frame 110 for the kth projection device 112 for iteration number n+1;
Yₖ⁽ⁿ⁾=low-resolution sub-frame 110 for the kth projection device 112 for iteration number n;
Θ=momentum parameter indicating the fraction of error to be incorporated at each iteration;
D=down-sampling matrix;
Hₖ^{T}=Transpose of interpolating filter, Hₖ, from Equation I (in the image domain, Hₖ^{T} is a flipped version of Hₖ);
Fₖ^{T}=Transpose of operator, Fₖ, from Equation II (in the image domain, Fₖ^{T} is the inverse of the warp denoted by Fₖ);
X-hat⁽ⁿ⁾=hypothetical or simulated high-resolution frame 306 in the reference projector frame buffer, as defined in Equation II, for iteration number n;
X=desired high-resolution frame 308;
β=smoothing constant; and
∇²=Laplacian operator.

Equation X may be intuitively understood as an iterative process of computing an error in the hypothetical reference projector coordinate system and projecting it back onto the sub-frame data. In one embodiment, sub-frame generator 108 is configured to generate sub-frames 110 in real-time using Equation X. The generated sub-frames 110 are optimal in one embodiment because they maximize the probability that the simulated high-resolution image 306 (X-hat) is the same as the desired high-resolution image 308 (X), and they minimize the error between the simulated high-resolution image 306 and the desired high-resolution image 308. Equation X can be implemented very efficiently with conventional image processing operations (e.g., transformations, down-sampling, and filtering). The iterative algorithm given by Equation X converges rapidly in a few iterations and is very efficient in terms of memory and computation (e.g., a single iteration uses two rows in memory; and multiple iterations may also be rolled into a single step). The iterative algorithm given by Equation X is suitable for real-time implementation, and may be used to generate optimal sub-frames 110 at video rates, for example.

To begin the iterative algorithm defined in Equation X, an initial guess, Yₖ⁽⁰⁾, for sub-frames 110 is determined. In one embodiment, the initial guess for sub-frames 110 is determined by texture mapping the desired high-resolution frame 308 onto sub-frames 110. In one embodiment, the initial guess is determined from the following Equation XI:

Yₖ⁽⁰⁾=DBₖFₖ^{T}X Equation XI

where:
k=index for identifying the projection devices 112;
Yₖ⁽⁰⁾=initial guess at the sub-frame data for the sub-frame 110 for the kth projection device 112;
D=down-sampling matrix;
Bₖ=interpolation filter;
Fₖ^{T}=Transpose of operator, Fₖ, from Equation II (in the image domain, Fₖ^{T} is the inverse of the warp denoted by Fₖ); and
X=desired high-resolution frame 308.

Thus, as indicated by Equation XI, the initial guess (Yₖ⁽⁰⁾) is determined by performing a geometric transformation (Fₖ^{T}) on the desired high-resolution frame 308 (X), and filtering (Bₖ) and down-sampling (D) the result. The particular combination of neighboring pixels from the desired high-resolution frame 308 that are used in generating the initial guess (Yₖ⁽⁰⁾) will depend on the selected filter kernel for the interpolation filter (Bₖ).

In another embodiment, the initial guess, Yₖ⁽⁰⁾, for sub-frames 110 is determined from the following Equation XII

Yₖ⁽⁰⁾=DFₖ^{T}X Equation XII

where:
k=index for identifying the projection devices 112;
Yₖ⁽⁰⁾=initial guess at the sub-frame data for the sub-frame 110 for the kth projection device 112;
D=down-sampling matrix;
Fₖ^{T}=Transpose of operator, Fₖ, from Equation II (in the image domain, Fₖ^{T} is the inverse of the warp denoted by Fₖ); and
X=desired high-resolution frame 308.

Equation XII is the same as Equation XI, except that the interpolation filter (Bₖ) is not used.

Several techniques are available to determine the geometric mapping (Fₖ) between each projection device 112 and hypothetical reference projector 118, including manually establishing the mappings, or using camera 122 and calibration unit 124 to automatically determine the mappings. In one embodiment, if camera 122 and calibration unit 124 are used, the geometric mappings between each projection device 112 and camera 122 are determined by calibration unit 124. These projector-to-camera mappings may be denoted by Tₖ, where k is an index for identifying projection devices 112. Based on the projector-to-camera mappings (Tₖ), the geometric mappings (Fₖ) between each projection device 112 and hypothetical reference projector 118 are determined by calibration unit 124, and provided to sub-frame generator 108. For example, in a display system 40 with two projection devices 112A and 112B, assuming the first projection device 112A is hypothetical reference projector 118, the geometric mapping of the second projection device 112B to the first (reference) projection device 112A can be determined as shown in the following Equation XIII:

F₂=T₂T₁⁻¹ Equation XIII

where:
F₂=operator that maps a low-resolution sub-frame 110 of the second projection device 112B to the first (reference) projection device 112A;
T₁=geometric mapping between the first projection device 112A and camera 122; and
T₂=geometric mapping between the second projection device 112B and camera 122.

In one embodiment, the geometric mappings (Fₖ) are determined once by calibration unit 124, and provided to sub-frame generator 108. In another embodiment, calibration unit 124 continually determines (e.g., once per frame 106) the geometric mappings (Fₖ), and continually provides updated values for the mappings to sub-frame generator 108.

B. Single Color Sub-Frames

In another embodiment illustrated by the embodiment of FIG. 7, sub-frame generator 108 determines and generates single-color sub-frames 110 for each projection device 112 that minimize color aliasing due to offset projection. This process may be thought of as inverse de-mosaicking. A de-mosaicking process seeks to synthesize a high-resolution, full color image free of color aliasing given color samples taken at relative offsets. In one embodiment, sub-frame generator 108 essentially performs the inverse of this process and determines the colorant values to be projected at relative offsets, given a full color high-resolution image 106. The generation of optimal sub-frames 110 based on a simulated high-resolution image and a desired high-resolution image is described in further detail below with reference to FIG. 7.

FIG. 7 is a diagram illustrating a model of an image formation process performed by sub-frame generator 108 in sub-frame generation system 20. Sub-frames 110 are represented in the model by Yᵢₖ, where “k” is an index for identifying individual sub-frames 110, and “i” is an index for identifying color planes. Two of the sixteen pixels of the sub-frame 110 shown in FIG. 7 are highlighted, and identified by reference numbers 400A-1 and 400B-1. Sub-frames 110 (Yᵢₖ) are represented on a hypothetical high-resolution grid by up-sampling (represented by Dᵢ^{T}) to create up-sampled image 401. The up-sampled image 401 is filtered with an interpolating filter (represented by Hᵢ) to create a high-resolution image 402 (Zᵢₖ) with “chunky pixels”. This relationship is expressed in the following Equation XIV:

Zᵢₖ=HᵢDᵢ^{T}Yᵢₖ Equation XIV

where:
k=index for identifying individual sub-frames 110;
i=index for identifying color planes;
Zᵢₖ=kth low-resolution sub-frame 110 in the ith color plane on a hypothetical high-resolution grid;
Hᵢ=Interpolating filter for low-resolution sub-frames 110 in the ith color plane;
Dᵢ^{T}=up-sampling matrix for sub-frames 110 in the ith color plane; and
Yᵢₖ=kth low-resolution sub-frame 110 in the ith color plane.

The low-resolution sub-frame pixel data (Yᵢₖ) is expanded with the up-sampling matrix (Dᵢ^{T}) so that sub-frames 110 (Yᵢₖ) can be represented on a high-resolution grid. The interpolating filter (Hᵢ) fills in the missing pixel data produced by up-sampling. In the embodiment shown in FIG. 7, pixel 400A-1 from the original sub-frame 110 (Yᵢₖ) corresponds to four pixels 400A-2 in the high-resolution image 402 (Zᵢₖ), and pixel 400B-1 from the original sub-frame 110 (Yᵢₖ) corresponds to four pixels 400B-2 in the high-resolution image 402 (Zᵢₖ). The resulting image 402 (Zᵢₖ) in Equation XIV models the output of the projection devices 112 if there was no relative distortion or noise in the projection process. Relative geometric distortion between the projected component sub-frames 110 results due to the different optical paths and locations of the component projection devices 112. A geometric transformation is modeled with the operator, Fᵢₖ, which maps coordinates in the frame buffer 113 of a projection device 112 to frame buffer 120 of hypothetical reference projector 118 with sub-pixel accuracy, to generate a warped image 404 (Z_{ref}). In one embodiment, Fᵢₖ is linear with respect to pixel intensities, but is non-linear with respect to the coordinate transformations. As shown in FIG. 7, the four pixels 400A-2 in image 402 are mapped to the three pixels 400A-3 in image 404, and the four pixels 400B-2 in image 402 are mapped to the four pixels 400B-3 in image 404.

In one embodiment, the geometric mapping (Fᵢₖ) is a floating-point mapping, but the destinations in the mapping are on an integer grid in image 404. Thus, it is possible for multiple pixels in image 402 to be mapped to the same pixel location in image 404, resulting in missing pixels in image 404. To avoid this situation, in one embodiment, during the forward mapping (Fᵢₖ), the inverse mapping (Fᵢₖ⁻¹) is also utilized as indicated at 405 in FIG. 7. Each destination pixel in image 404 is back projected (i.e., Fᵢₖ⁻¹) to find the corresponding location in image 402. For the embodiment shown in FIG. 7, the location in image 402 corresponding to the upper-left pixel of the pixels 400A-3 in image 404 is the location at the upper-left corner of the group of pixels 400A-2. In one embodiment, the values for the pixels neighboring the identified location in image 402 are combined (e.g., averaged) to form the value for the corresponding pixel in image 404. Thus, for the example shown in FIG. 7, the value for the upper-left pixel in the group of pixels 400A-3 in image 404 is determined by averaging the values for the four pixels within the frame 403 in image 402.

In another embodiment, the forward geometric mapping or warp (Fₖ) is implemented directly, and the inverse mapping (Fₖ⁻¹) is not used. In one form of this embodiment, a scatter operation is performed to eliminate missing pixels. That is, when a pixel in image 402 is mapped to a floating point location in image 404, some of the image data for the pixel is essentially scattered to multiple pixels neighboring the floating point location in image 404. Thus, each pixel in image 404 may receive contributions from multiple pixels in image 402, and each pixel in image 404 is normalized based on the number of contributions it receives.

A superposition/summation of such warped images 404 from all of the component projection devices 112 in a given color plane forms a hypothetical or simulated high-resolution image (X-hatᵢ) for that color plane in reference projector frame buffer 120, as represented in the following Equation XV:

$${\hat{X}}_{i} = {\sum }_{k} {F}_{ik} {Z}_{ik} \qquad Equation XV$$

where:
k=index for identifying individual sub-frames 110;
i=index for identifying color planes;
X-hatᵢ=hypothetical or simulated high-resolution image for the ith color plane in the reference projector frame buffer 120;
Fᵢₖ=operator that maps the kth low-resolution sub-frame 110 in the ith color plane on a hypothetical high-resolution grid to the reference projector frame buffer 120; and
Zᵢₖ=kth low-resolution sub-frame 110 in the ith color plane on a hypothetical high-resolution grid, as defined in Equation XIV.

A hypothetical or simulated image 406 (X-hat) is represented by the following Equation XVI:

\hat{X}=[\hat{X}₁\hat{X}₂ . . . \hat{X}_{N}]^{T} Equation XVI

where:
X-hat=hypothetical or simulated high-resolution image in reference projector frame buffer 120;
X-hat₁=hypothetical or simulated high-resolution image for the first color plane in reference projector frame buffer 120, as defined in Equation XV;
X-hat₂=hypothetical or simulated high-resolution image for the second color plane in reference projector frame buffer 120, as defined in Equation XV;
X-hat_{N}=hypothetical or simulated high-resolution image for the Nth color plane in reference projector frame buffer 120, as defined in Equation XV; and
N=number of color planes.

If the simulated high-resolution image 406 (X-hat) in reference projector frame buffer 120 is identical to a given (desired) high-resolution image 408 (X), the system of component low-resolution projection devices 112 would be equivalent to a hypothetical high-resolution projector placed at the same location as hypothetical reference projector 118 and sharing its optical path. In one embodiment, the desired high-resolution images 408 are the high-resolution image frames 106 received by sub-frame generator 108.

In one embodiment, the deviation of the simulated high-resolution image 406 (X-hat) from the desired high-resolution image 408 (X) is modeled as shown in the following Equation XVII:

X=\hat{X}+η Equation XVII

where:
X=desired high-resolution frame 408;
X-hat=hypothetical or simulated high-resolution frame 406 in reference projector frame buffer 120; and
η=error or noise term.

As shown in Equation XVII, the desired high-resolution image 408 (X) is defined as the simulated high-resolution image 406 (X-hat) plus η, which in one embodiment represents zero mean white Gaussian noise.

The solution for the optimal sub-frame data (Yᵢₖ*) for sub-frames 110 is formulated as the optimization given in the following Equation XVIII:

$${Y}_{ik}^{*} = {arg max}_{{Y}_{ik}} P ( \hat{X} \vert X ) \qquad Equation XVIII$$

where:
k=index for identifying individual sub-frames 110;
i=index for identifying color planes;
Yᵢₖ*=optimum low-resolution sub-frame data for the kth sub-frame 110 in the ith color plane;
Yᵢₖ=kth low-resolution sub-frame 110 in the ith color plane;
X-hat=hypothetical or simulated high-resolution frame 406 in reference projector frame buffer 120, as defined in Equation XVI;
X=desired high-resolution frame 408; and
P(X-hat|X)=probability of X-hat given X.

Thus, as indicated by Equation XVIII, the goal of the optimization is to determine the sub-frame values (Yᵢₖ) that maximize the probability of X-hat given X. Given a desired high-resolution image 408 (X) to be projected, sub-frame generator 108 determines the component sub-frames 110 that maximize the probability that the simulated high-resolution image 406 (X-hat) is the same as or matches the “true” high-resolution image 408 (X).

Using Bayes rule, the probability P(X-hat|X) in Equation XVIII can be written as shown in the following Equation XIX:

$$P \text{(} \hat{X} \vert X ) = \frac{P ( X \vert \hat{X} ) P ( \hat{X} )}{P ( X )} \qquad Equation XIX$$

where:
X-hat=hypothetical or simulated high-resolution frame 406 in reference projector frame buffer 120, as defined in Equation XVI;
X=desired high-resolution frame 408;
P(X-hat|X)=probability of X-hat given X;
P(X|X-hat)=probability of X given X-hat;
P(X-hat)=prior probability of X-hat; and
P(X)=prior probability of X.

The term P(X) in Equation XIX is a known constant. If X-hat is given, then, referring to Equation XVII, X depends only on the noise term, η, which is Gaussian. Thus, the term P(X|X-hat) in Equation XIX will have a Gaussian form as shown in the following Equation XX:

$$P \text{(} X \vert \hat{X} ) = \frac{1}{C} {e}^{- {\sum }_{i} \frac{( {‖ {X}_{i} - {\hat{X}}_{i} ‖}^{2} )}{2 {σ}_{i}^{2}}} \qquad Equation XX$$

where:
X-hat=hypothetical or simulated high-resolution frame 406 in reference projector frame buffer 120, as defined in Equation XVI;
X=desired high-resolution frame 408;
P(X|X-hat)=probability of X given X-hat;
C=normalization constant;
i=index for identifying color planes;
Xᵢ=ith color plane of the desired high-resolution frame 408;
X-hatᵢ=hypothetical or simulated high-resolution image for the ith color plane in the reference projector frame buffer 120, as defined in Equation XV; and
σᵢ=variance of the noise term, η, for the ith color plane.

To provide a solution that is robust to minor calibration errors and noise, a “smoothness” requirement is imposed on X-hat. In other words, it is assumed that good simulated images 406 have certain properties. For example, for most good color images, the luminance and chrominance derivatives are related by a certain value. In one embodiment, a smoothness requirement is imposed on the luminance and chrominance of the X-hat image based on a “Hel-Or” color prior model, which is a conventional color model known to those of ordinary skill in the art. The smoothness requirement according to one embodiment is expressed in terms of a desired probability distribution for X-hat given by the following Equation XXI:

$$P ( \hat{X} ) = \frac{1}{Z ( α , β )} {e}^{- \{ {α}^{2} ( {‖ ∇ {\hat{C}}_{1} ‖}^{2} + {‖ ∇ {\hat{C}}_{2} ‖}^{2} + {β}^{2} ( {‖ ∇ \hat{L} ‖}^{2} ) \}} \qquad Equation XXI$$

where:
P(X-hat)=prior probability of X-hat;
α and β=smoothing constants;
Z(α,β)=normalization function;
∇=gradient operator; and
C-hat₁=first chrominance channel of X-hat;
C-hat₂=second chrominance channel of X-hat; and
L-hat=luminance of X-hat.

In another embodiment, the smoothness requirement is based on a prior Laplacian model, and is expressed in terms of a probability distribution for X-hat given by the following Equation XXII:

$$P ( \hat{X} ) = \frac{1}{Z ( α , β )} {e}^{- \{ α ( ‖ ∇ {\hat{C}}_{1} ‖ + ‖ ∇ {\hat{C}}_{2} ‖ + β ( ‖ ∇ \hat{L} ‖ ) \}} \qquad Equation XXII$$

where:
P(X-hat)=prior probability of X-hat;
α and β=smoothing constants;
Z(α,β)=normalization function;
∇=gradient operator; and
C-hat₁=first chrominance channel of X-hat;
C-hat₂=second chrominance channel of X-hat; and
L-hat=luminance of X-hat.

The following discussion assumes that the probability distribution given in Equation XXI, rather than Equation XXII, is being used. As will be understood by persons of ordinary skill in the art, a similar procedure would be followed if Equation XXII were used. Inserting the probability distributions from Equations XX and XXI into Equation XIX, and inserting the result into Equation XVIII, results in a maximization problem involving the product of two probability distributions (note that the probability P(X) is a known constant and goes away in the calculation). By taking the negative logarithm, the exponents go away, the product of the two probability distributions becomes a sum of two probability distributions, and the maximization problem given in Equation V is transformed into a function minimization problem, as shown in the following Equation XXIII:

$${Y}_{ik}^{*} = {arg min}_{{Y}_{ik}} {\sum }_{i = 1}^{N} {‖ {X}_{i} - {\hat{X}}_{i} ‖}^{2} + {α}^{2} \{ ‖ ∇ {( {\sum }_{i = 1}^{N} {T}_{{C}_{1} i} {\hat{X}}_{i} ‖}^{2} + ‖ ∇ {( {\sum }_{i = 1}^{N} {T}_{{C}_{2} i} {\hat{X}}_{i} ‖}^{2} \} + {β}^{2} ‖ ∇ {( {\sum }_{i = 1}^{N} {T}_{Li} {\hat{X}}_{i} ‖}^{2} \qquad Equation XXIII$$

where:
k=index for identifying individual sub-frames 110;
i=index for identifying color planes;
Yᵢₖ*=optimum low-resolution sub-frame data for the kth sub-frame 110 in the ith color plane;
Yᵢₖ=kth low-resolution sub-frame 110 in the ith color plane;
N=number of color planes;
Xᵢ=ith color plane of the desired high-resolution frame 408;
X-hatᵢ=hypothetical or simulated high-resolution image for the ith color plane in the reference projector frame buffer 120, as defined in Equation XV;
α and β=smoothing constants;
∇=gradient operator;
T_{C1i}=ith element in the second row in a color transformation matrix, T, for transforming the first chrominance channel of X-hat;
T_{C2i}=ith element in the third row in a color transformation matrix, T, for transforming the second chrominance channel of X-hat; and
T_{Li}=ith element in the first row in a color transformation matrix, T, for transforming the luminance of X-hat.

The function minimization problem given in Equation XXIII is solved by substituting the definition of X-hatᵢ from Equation XV into Equation XXIII and taking the derivative with respect to Yᵢₖ, which results in an iterative algorithm given by the following Equation XXIV:

$${Y}_{ik}^{( n + 1 )} = {Y}_{ik}^{( n )} - Θ \{ {D}_{i} {F}_{ik}^{T} {H}_{i}^{T} [ ( {\hat{X}}_{i}^{( n )} - {X}_{i} ) + {α}^{2} {∇}^{2} ( {T}_{{C}_{1} i} {{\sum }_{j = 1}^{N}}^{ } {T}_{{C}_{1} j} {\hat{X}}_{j}^{( n )} + {T}_{{C}_{2} j} {\sum }_{j = 1}^{N} {T}_{{C}_{2} i} {\hat{X}}_{j}^{( n )} ) … + {β}^{2} {∇}^{2} {T}_{Li} {\sum }_{j = 1}^{N} {T}_{Lj} {\hat{X}}_{j}^{( n )} ] \} \qquad Equation XXIV$$

where:
k=index for identifying individual sub-frames 110;
i and j=indices for identifying color planes;
n=index for identifying iterations;
Yᵢₖ⁽ⁿ⁺¹⁾=kth low-resolution sub-frame 110 in the ith color plane for iteration number n+1;
Yᵢₖ⁽ⁿ⁾=kth low-resolution sub-frame 110 in the ith color plane for iteration number n;
Θ=momentum parameter indicating the fraction of error to be incorporated at each iteration;
Dᵢ=down-sampling matrix for the ith color plane;
Hᵢ^{T}=Transpose of interpolating filter, Hᵢ, from Equation XIV (in the image domain, Hᵢ^{T} is a flipped version of Hᵢ);
Fᵢₖ^{T}=Transpose of operator, Fᵢₖ, from Equation XV (in the image domain, Fᵢₖ^{T} is the inverse of the warp denoted by Fᵢₖ);
X-hatᵢ⁽ⁿ⁾=hypothetical or simulated high-resolution image for the ith color plane in the reference projector frame buffer 120, as defined in Equation XV, for iteration number n;
Xᵢ=ith color plane of the desired high-resolution frame 408;
α and β=smoothing constants;
∇²=Laplacian operator;
T_{C1i}=ith element in the second row in a color transformation matrix, T, for transforming the first chrominance channel of X-hat;
T_{C2i}=ith element in the third row in a color transformation matrix, T, for transforming the second chrominance channel of X-hat;
T_{Li}=ith element in the first row in a color transformation matrix, T, for transforming the luminance of X-hat;
X-hatⱼ⁽ⁿ⁾=hypothetical or simulated high-resolution image for the jth color plane in the reference projector frame buffer 120, as defined in Equation XV, for iteration number n;
T_{C1j}=jth element in the second row in a color transformation matrix, T, for transforming the first chrominance channel of X-hat;
T_{C2j}=jth element in the third row in a color transformation matrix, T, for transforming the second chrominance channel of X-hat;
T_{Lj}=jth element in the first row in a color transformation matrix, T, for transforming the luminance of X-hat; and
N=number of color planes.

Equation XXIV may be intuitively understood as an iterative process of computing an error in the hypothetical reference projector coordinate system and projecting it back onto the sub-frame data. In one embodiment, sub-frame generator 108 is configured to generate sub-frames 110 in real-time using Equation XXIV. The generated sub-frames 110 are optimal in one embodiment because they maximize the probability that the simulated high-resolution image 406 (X-hat) is the same as the desired high-resolution image 408 (X), and they minimize the error between the simulated high-resolution image 406 and the desired high-resolution image 408. Equation XXIV can be implemented very efficiently with conventional image processing operations (e.g., transformations, down-sampling, and filtering). The iterative algorithm given by Equation XXIV converges rapidly in a few iterations and is very efficient in terms of memory and computation (e.g., a single iteration uses two rows in memory; and multiple iterations may also be rolled into a single step). The iterative algorithm given by Equation XXIV is suitable for real-time implementation, and may be used to generate optimal sub-frames 110 at video rates, for example.

To begin the iterative algorithm defined in Equation XXIV, an initial guess, Yᵢₖ⁽⁰⁾, for sub-frames 110 is determined. In one embodiment, the initial guess for sub-frames 110 is determined by texture mapping the desired high-resolution frame 408 onto sub-frames 110. In one embodiment, the initial guess is determined from the following Equation XXV:

Yᵢₖ⁽⁰⁾=DᵢBᵢFᵢₖ^{T}Xᵢ Equation XXV

where:
k=index for identifying individual sub-frames 110;
i=index for identifying color planes;
Yᵢₖ⁽⁰⁾=initial guess at the sub-frame data for the kth sub-frame 110 for the ith color plane;
Dᵢ=down-sampling matrix for the ith color plane;
Bᵢ=interpolation filter for the ith color plane;
Fᵢₖ^{T}=Transpose of operator, Fᵢₖ, from Equation II (in the image domain, Fᵢₖ^{T} is the inverse of the warp denoted by Fᵢₖ); and
Xᵢ=ith color plane of the desired high-resolution frame 408.

Thus, as indicated by Equation XXV, the initial guess (Yᵢₖ⁽⁰⁾) is determined by performing a geometric transformation (Fᵢₖ^{T}) on the ith color plane of the desired high-resolution frame 408 (Xᵢ), and filtering (Bᵢ) and down-sampling (Dᵢ) the result. The particular combination of neighboring pixels from the desired high-resolution frame 408 that are used in generating the initial guess (Yᵢₖ⁽⁰⁾) will depend on the selected filter kernel for the interpolation filter (Bᵢ).

In another embodiment, the initial guess, Yᵢₖ⁽⁰⁾, for sub-frames 110 is determined from the following Equation XXVI:

Yᵢₖ⁽⁰⁾=DᵢFᵢₖ^{T}Xᵢ Equation XXVI

where:
k=index for identifying individual sub-frames 110;
i=index for identifying color planes;
Yᵢₖ⁽⁰⁾=initial guess at the sub-frame data for the kth sub-frame 110 for the ith color plane;
Dᵢ=down-sampling matrix for the ith color plane;
Fᵢₖ^{T}=Transpose of operator, Fᵢₖ, from Equation II (in the image domain, Fᵢₖ^{T} is the inverse of the warp denoted by Fᵢₖ); and
Xᵢ=ith color plane of the desired high-resolution frame 408.

Equation XXVI is the same as Equation XXV, except that the interpolation filter (Bₖ) is not used.

Several techniques are available to determine the geometric mapping (Fᵢₖ) between each projection device 112 and hypothetical reference projector 118, including manually establishing the mappings, or using camera 122 and calibration unit 124 to automatically determine the mappings. In one embodiment, if camera 122 and calibration unit 124 are used, the geometric mappings between each projection device 112 and camera 122 are determined by calibration unit 124. These projector-to-camera mappings may be denoted by Tₖ, where k is an index for identifying projection devices 112. Based on the projector-to-camera mappings (Tₖ), the geometric mappings (Fₖ) between each projection device 112 and hypothetical reference projector 118 are determined by calibration unit 124, and provided to sub-frame generator 108. For example, in a display system 40 with two projection devices 112A and 112B, assuming the first projection device 112A is hypothetical reference projector 118, the geometric mapping of the second projection device 112B to the first (reference) projection device 112A can be determined as shown in the following Equation XXVII:

F₂=T₂T₁⁻¹ Equation XXVII

where:
F₂=operator that maps a low-resolution sub-frame 110 of the second projection device 112B to the first (reference) projection device 112A;
T₁=geometric mapping between the first projection device 112A and camera 122; and
T₂=geometric mapping between the second projection device 112B and camera 122.

In one embodiment, the geometric mappings (Fᵢₖ) are determined once by calibration unit 124, and provided to sub-frame generator 108. In another embodiment, calibration unit 124 continually determines (e.g., once per frame 106) the geometric mappings (Fᵢₖ), and continually provides updated values for the mappings to sub-frame generator 108.

One embodiment provides an image display system 40 with multiple overlapped low-resolution projection devices 112 coupled with an efficient real-time (e.g., video rates) image processing algorithm for generating sub-frames 110. In one embodiment, multiple low-resolution, low-cost projection devices 112 are used to produce high resolution images at high lumen levels, but at lower cost than existing high-resolution projection systems, such as a single, high-resolution, high-output projector. One embodiment provides a scalable image display system 40 that can provide virtually any desired resolution, brightness, and color, by adding any desired number of component projection devices 112 to the system 40.

In some existing display systems, multiple low-resolution images are displayed with temporal and sub-pixel spatial offsets to enhance resolution. There are some important differences between these existing systems and embodiments described herein. For example, in one embodiment, there is no need for circuitry to offset the projected sub-frames 110 temporally. In one embodiment, sub-frames 110 from the component projection devices 112 are projected “in-sync”. As another example, unlike some existing systems where all of the sub-frames go through the same optics and the shifts between sub-frames are all simple translational shifts, in one embodiment, sub-frames 110 are projected through the different optics of the multiple individual projection devices 112. In one embodiment, the signal processing model that is used to generate optimal sub-frames 110 takes into account relative geometric distortion among the component sub-frames 110, and is robust to minor calibration errors and noise.

It can be difficult to accurately align projectors into a desired configuration. In one embodiment, regardless of what the particular projector configuration is, even if it is not an optimal alignment, sub-frame generator 108 determines and generates optimal sub-frames 110 for that particular configuration.

Algorithms that seek to enhance resolution by offsetting multiple projection elements have been previously proposed. These methods may assume simple shift offsets between projectors, use frequency domain analyses, and rely on heuristic methods to compute component sub-frames. In contrast, one form of the embodiments described herein utilize an optimal real-time sub-frame generation algorithm that explicitly accounts for arbitrary relative geometric distortion (not limited to homographies) between the component projection devices 112, including distortions that occur due to a display surface that is non-planar or has surface non-uniformities. One embodiment generates sub-frames 110 based on a geometric relationship between a hypothetical high-resolution hypothetical reference projector at any arbitrary location and each of the actual low-resolution projection devices 112, which may also be positioned at any arbitrary location.

In one embodiment, system 40 includes multiple overlapped low-resolution projection devices 112, with each projection device 112 projecting a different colorant to compose a full color high-resolution image on the display surface with minimal color artifacts due to the overlapped projection. By imposing a color-prior model via a Bayesian approach as is done in one embodiment, the generated solution for determining sub-frame values minimizes color aliasing artifacts and is robust to small modeling errors.

Using multiple off the shelf projection devices 112 in system 40 allows for high resolution. However, if the projection devices 112 include a color wheel, which is common in existing projectors, the system 40 may suffer from light loss, sequential color artifacts, poor color fidelity, reduced bit-depth, and a significant tradeoff in bit depth to add new colors. One embodiment described herein eliminates the need for a color wheel, and uses in its place, a different color filter for each projection device 112. Thus, in one embodiment, projection devices 112 each project different single-color images. By not using a color wheel, segment loss at the color wheel is eliminated, which could be up to a 30% loss in efficiency in single chip projectors. One embodiment increases perceived resolution, eliminates sequential color artifacts, improves color fidelity since no spatial or temporal dither is required, provides a high bit-depth per color, and allows for high-fidelity color.

Image display system 40 is also very efficient from a processing perspective since, in one embodiment, each projection device 112 only processes one color plane. Thus, each projection device 112 reads and renders only one-third (for RGB) of the full color data.

In one embodiment, image display system 40 is configured to project images that have a three-dimensional (3D) appearance. In 3D image display systems, two images, each with a different polarization, are simultaneously projected by two different projectors. One image corresponds to the left eye, and the other image corresponds to the right eye. Conventional 3D image display systems typically suffer from a lack of brightness. In contrast, with one embodiment, a first plurality of the projection devices 112 may be used to produce any desired brightness for the first image (e.g., left eye image), and a second plurality of the projection devices 112 may be used to produce any desired brightness for the second image (e.g., right eye image). In another embodiment, image display system 40 may be combined or used with other display systems or display techniques, such as tiled displays.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method performed by a sub-frame generator coupled to a network interface, the method comprising:
receiving calibration information associated with a configuration of a plurality of projection devices in an image display system using the network interface;
generating a plurality of sub-frames for display onto at least partially overlapping positions on a display surface by the plurality of projection devices using image data and the calibration information; and
transmitting the plurality of sub-frames to the image display system using the network interface.

2. The method of claim 1 further comprising:
configuring the plurality of sub-frames in accordance with a network protocol prior to transmitting the plurality of sub-frames.

3. The method of claim 1 further comprising:
transmitting the plurality of sub-frames by providing the plurality of sub-frames to a network coupled to the network interface.

4. The method of claim 1 wherein the calibration information includes a geometric relationship between a hypothetical reference projector and each of the plurality of projection devices.

5. The method of claim 1 further comprising:
generating each of the plurality of sub-frames with distortion
wherein the plurality of sub-frames are generated to cause the distortion not to be visible in response to being simultaneously displayed in at least partially overlapping positions using the first one of the plurality of sub-frames and the second one of the plurality of sub-frames, respectively.

6. The method of claim 5 wherein the plurality of sub-frames is generated to cause the distortion to be visible in response to fewer than all of the plurality of sub-frames being simultaneously displayed.

7. The method of claim 1 further comprising:
encrypting the plurality of sub-frames prior to transmitting the plurality of sub-frames.

8. The method of claim 1 further comprising:
compressing the plurality of sub-frames prior to transmitting the plurality of sub-frames.

9. The method of claim 1 further comprising:
receiving diagnostic information from the image display system using the network interface.

10. A display system comprising:
a plurality of projection devices;
a calibration unit; and
a network interface;
wherein the calibration unit is configured to transmit calibration information associated with a configuration of the plurality of projection devices using the network interface, wherein the network interface is configured to receive a plurality of sub-frames generated using the calibration information, and wherein the plurality of projection devices is configured to display the plurality of sub-frames onto at least partially overlapping positions on a display surface.

11. The display system of claim 10 wherein the network interface configures the calibration information in accordance with a network protocol prior to transmitting the calibration information.

12. The display system of claim 10 wherein the network interface is configured to transmit the calibration information by providing the calibration information to a network coupled to the network interface.

13. The display system of claim 10 wherein the calibration information includes a geometric relationship between a hypothetical reference projection device and each of the plurality of projection devices.

14. The display system of claim 10 wherein the calibration unit is configured to encrypt the calibration information prior to transmitting the calibration information.

15. The display system of claim 10 further comprising:
a control unit configured to generate diagnostic information associated with at least one of the plurality of projection devices and transmit the diagnostic information using the network interface.

16. A sub-frame generation system comprising:
a sub-frame generator configured to generate a plurality of sub-frames using image data and calibration information received across a network from a remotely located image display system, the calibration information identifying a configuration of a plurality of projection devices in the remotely located image display system; and
a network interface configured to transmit the plurality of sub-frames to the remotely located image display system using the network.

17. The sub-frame generation system of claim 16 wherein the sub-frame generator is configured to generate the plurality of sub-frames to include a plurality of moire patterns such that the moire patterns are not visible in response to a plurality of images being simultaneously displayed in at least partially overlapping positions using the plurality of sub-frames.

18. The sub-frame generation system of claim 16 wherein the sub-frame generator is configured to encrypt the plurality of sub-frames.

19. The sub-frame generation system of claim 16 wherein the sub-frame generator is configured to compress the plurality of sub-frames using redundant information in the plurality of sub-frames.

20. The sub-frame generation system of claim 16 wherein the plurality of sub-frames is generated based on maximization of a probability that a simulated image is the same as the image data.
